(19) United States
(12) Patent Application Publication
(10) Pub. No.: US 2006/0246890 A1
(43) Pub. Date: Nov. 2, 2006

(54) Mobile radio terminal apparatus

(75) Inventors: Chikara Yasuda, Kunitachi-shi (JP); Yoshiyuki Kubo, Ome-shi (JP); Naritoshi Saito, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/241,307

(22) Filed: Sep. 30, 2005

(30) Foreign Application Priority Data
Apr. 28, 2005 (JP) 2005-132853

(51) Int. Cl. H04Q 7/20

(52) U.S. Cl. 455/425; 455/550.1

(57) ABSTRACT

Control unit controls sender-receiver unit to execute cell search. As a result, if control unit attempts location registration via base station and the use is rejected, control unit stores identification information of the network to which the base station belongs in inhibit network list storage area, stores identification information of a carrier frequency used for communications with the base station in inhibit frequency list storage area, and detects a cell capable of carrying out communications on the basis of the identification information stored in the storage areas.

### CROSS-REFERENCE TO RELATED APPLICATIONS

This application is based upon and claims the benefit of priority from prior Japanese Patent Application No. 2005-132853, filed Apr. 28, 2005, the entire contents of which are incorporated herein by reference.

### BACKGROUND OF THE INVENTION

1. Field of the Invention

This invention relates to a mobile radio terminal apparatus capable of roaming, for example, in domestic areas or overseas.

2. Description of the Related Art

A conventional mobile radio terminal apparatus, as is well known, determines a roaming inhibit network on the basis of a network number included in information notified by a base station accommodated in a mobile communications network. For this reason, if the apparatus is located within a roaming inhibit network area, the apparatus consumes power for reception of the notified information on a roaming inhibit network cell (for example, 3GPP Standard TS24.008, TS25.331). In addition, another problem arises that detection of the cell in home network/roaming network is delayed due to unnecessary notified information reception.

### BRIEF SUMMARY OF THE INVENTION

The present invention has been accomplished to solve the above-described problems. The object of the present invention is to provide a mobile radio terminal apparatus capable of decreasing power to be consumed for reception of information notified from a base station and preventing a delay of cell detection of a home network/roaming network caused by unnecessary notified information reception even if the apparatus is located within a roaming inhibit network area.

To achieve this object, an aspect of the present invention is a radio communication apparatus for communicating by radio with base stations in a radio communications network. The apparatus comprises a first memory configured to store carrier frequencies available for connections with the base stations, a receiver configured to receive radio signals from the base stations, a second memory configured to store carrier frequencies at which the receiver receives signals to reject connections with the base stations, and a searcher configured to search a connectable base station at the carrier frequencies stored by the first memory other than the carrier frequencies stored by the second memory.

To achieve the object, an aspect of the present invention is a radio communication apparatus for communicating by radio with base stations in a radio communications network. The apparatus comprise a inhibit network memory configured to store identification information of a radio communications network in which the apparatus's roaming is not permitted, a first memory configured to store carrier frequencies available for connections with the base stations, a receiver configured to receive radio signals from the base stations to obtain identification information of a radio communications network to which each of the base stations belong, a second memory configured to store carrier frequencies used for connections with the base stations of which identification information is stored by the inhibit network memory, and a searcher configured to search a connectable base station at the carrier frequencies stored by the first memory other than the carrier frequencies stored by the second memory.

The present invention can provide a mobile radio terminal apparatus capable of decreasing power to be consumed for reception of information notified from a base station and preventing a delay of cell detection of a home network/roaming network caused by unnecessary notified information reception even if the apparatus is located within a roaming inhibit network area.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a mobile radio terminal apparatus according to a first embodiment of the present invention;

FIG. 2 is a table showing information stored in an inhibit frequency list storage area of the mobile radio terminal apparatus shown in FIG. 1;

FIG. 3 is a flowchart showing operations of the mobile radio terminal apparatus shown in FIG. 1;

FIG. 4 is a flowchart showing operations of the mobile radio terminal apparatus shown in FIG. 1;

FIG. 5 is a block diagram showing a structure of a mobile radio terminal apparatus according to a second embodiment of the present invention;

FIG. 6 is a flowchart showing operations of the mobile radio terminal apparatus shown in FIG. 5;

FIG. 7 is an illustration showing frequencies subjected to cell search as conducted in a modified example of the mobile radio terminal apparatus shown in FIG. 5;

FIG. 8 is a block diagram showing a structure of a mobile radio terminal apparatus according to a third embodiment of the present invention;

FIG. 9 is a flowchart showing operations of the mobile radio terminal apparatus shown in FIG. 8; and

FIG. 10 is an illustration showing frequencies subjected to cell search as conducted in the mobile radio terminal apparatus shown in FIG. 9.

### DETAILED DESCRIPTION OF THE INVENTION

Embodiments of the present invention will be explained below with reference to the accompanying drawings.

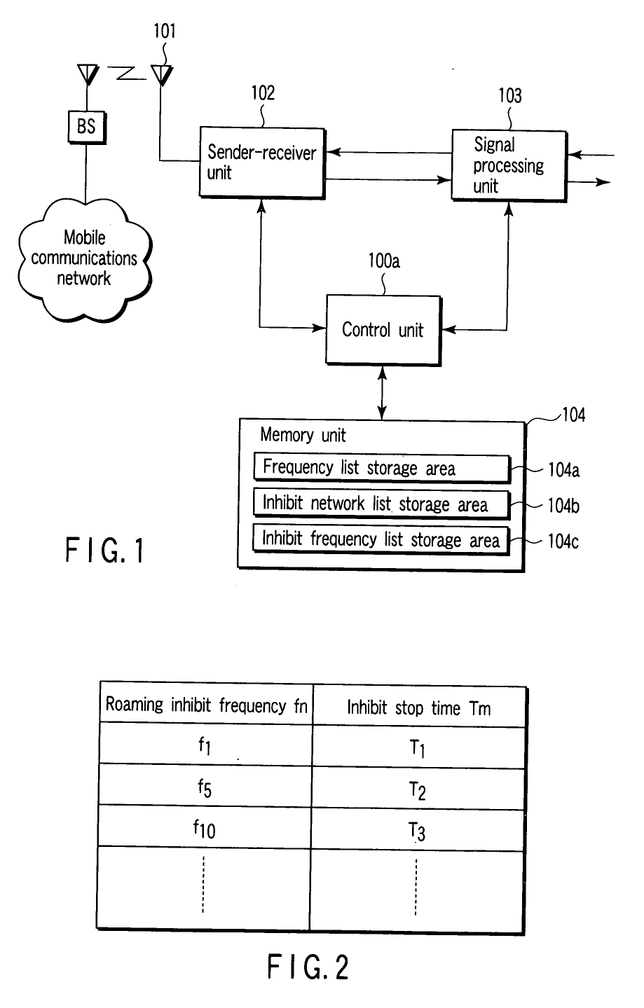

FIG. 1 shows a structure of a mobile radio terminal apparatus according to a first embodiment of the present invention. The mobile radio terminal apparatus comprises an antenna 101, a sender-receiver unit 102, a signal processing unit 103, a memory unit 104, and a control unit 100a. As an example of mobile radio terminal apparatus, an apparatus employed in a mobile radio communications system of W-CDMA (Wideband Code Division Multiple Access) scheme to conduct voice and data communications, will be described here.

The sender-receiver unit 102 conducts W-CDMA radio communications with a base station BS accommodated in a mobile communications network via the antenna 101. Specifically, the sender-receiver unit 102 generates a radio signal of a carrier frequency instructed by the control unit 100a, on the basis of a modulation signal generated by the signal processing unit 103. In addition, the sender-receiver unit 102 receives a radio signal of a carrier frequency instructed by the control unit 100a. A result of the reception is output to the signal processing unit 103 and the control unit 100a.

The signal processing unit 103 encodes a transmit speech signal. In addition, the signal processing unit 103 generates the modulation signal on the basis of the speech data obtained by encoding or other data, and outputs the generated modulation signal to the sender-receiver unit 102. Moreover, the signal processing unit 103 demodulates the signal received by the sender-receiver unit 102, and decodes a result of the demodulation to obtain the speech data and the like.

The memory unit 104 stores control programs and control data of the own mobile radio terminal apparatus, and inherent identification information assigned to the mobile radio terminal apparatus and its user, in addition to telephone directory data in which names correspond to telephone numbers, data obtained from data communications, and downloaded data. In addition, the memory unit 104 comprises a frequency list storage area 104a, an inhibit network list storage area 104b and an inhibit frequency list storage area 104c.

The frequency list storage area 104a stores a list of identification information on all of carrier frequencies that are available in a home network and a roaming network. In the W-CDMA scheme, the storage area is assumed to store the identification information on about three hundred carrier frequencies. In the mobile radio terminal apparatus which is applicable to both W-CDMA scheme and GSM (Global System for Mobile communication) scheme, the storage area is assumed to store the identification information on more than one thousand carrier frequencies.

The inhibit network list storage area 104b stores a list of identification information on networks which are unavailable at the time of roaming. The inhibit frequency list storage area 104c stores a list in which the identification information on the carrier frequencies unavailable at the time of roaming corresponds to the information on an inhibit stop time. FIG. 2 shows an example of the list. Due to mounting, the storage area may store the identification information on about ten carrier frequencies.

The control unit 100 controls each unit of the mobile radio terminal apparatus on the basis of the control program and control data stored in the memory unit 104. Specifically, the control unit 100 controls the carrier frequency used by the sender-receiver unit 102 and searches for a pilot signal on the basis of a result of the reception, and controls updating of the information stored in the inhibit network list storage area 104b and the inhibit frequency list storage area 104c. In addition, the control unit 100 comprises a timer function which counts the time.

The mobile radio terminal apparatus comprises a speaker which outputs a receive speech signal, a microphone which inputs a send speech signal, means for converting the speech data into the receive speech signal, means for converting the send speech signal into the speech data, display means for displaying images on the basis of the receive data, an operation unit which accepts a request for the user, and the like, though they are not shown in FIG. 1.

Next, operations of the mobile radio terminal apparatus having the above-explained structure are described. Particularly, operations of searching for the home network and roaming network are described, but descriptions about steps of establishing a communications link with a base station BS, control to implement the speech and data communications, registration, call and editing of the telephone directory data, and the like are omitted.

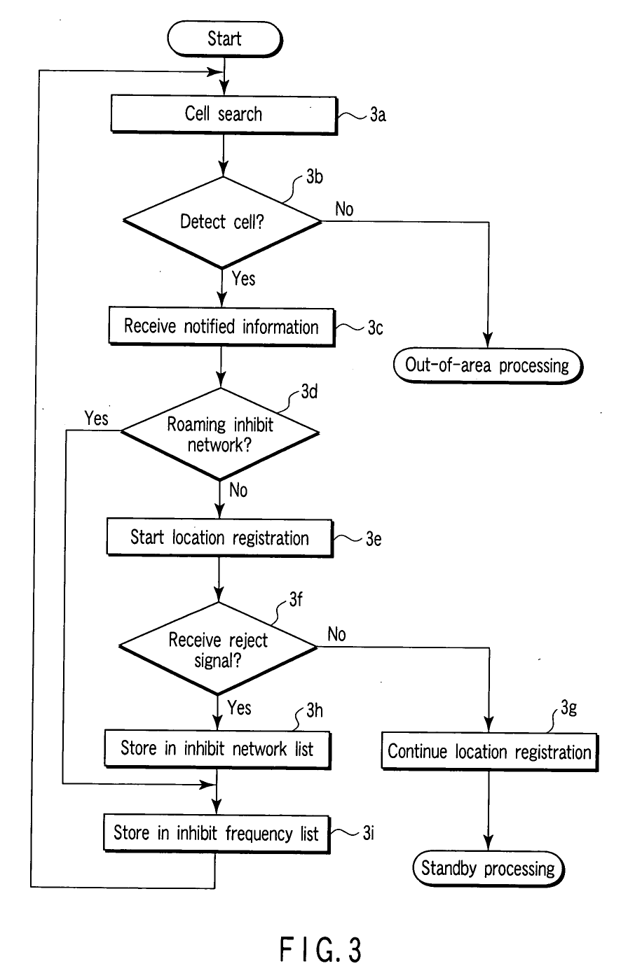

FIG. 3 is a flowchart showing the operations of searching for the home network and roaming network. This processing is executed by the control unit 10a. A control program to execute the control shown in the flowchart is stored in the memory unit 104. This processing is executed when the power is turned on or every time a predetermined time elapses after it is detected that the apparatus is located out of the service area.

First, in step 3a, the control unit 100a controls the sender-receiver unit 102 and executes cell search to search for the pilot signal sent from the base station BS, on the basis of the information stored in the frequency list storage area 104a and inhibit frequency list storage area 104c. The control unit 100a shifts to step 3b. Details of the cell search will be described later.

In step 3b, the control unit 100a determines whether or not the pilot signal could be detected in step 3a. If the pilot signal could be detected, the control unit 100a shifts to step 3c. If the pilot signal could not be detected, the control unit 100a terminates this processing and executes an out-of-area processing to urge the display unit to display a message that the mobile radio terminal apparatus is located out of the area where it cannot be employed.

In step 3c, the control unit 100a designates the carrier frequency which has been used to detect the pilot signal in step 3a, for the sender-receiver unit 102, and urges the sender-receiver unit 102 to receive the notified information sent from the base station BS. The control unit 100a shifts to step 3d. The notified information implies information of PLMN (Public Land Mobile Network) or the like. The PLMN includes MCC (Mobile Country Code) and MNC (Mobile Network Code).

In step 3d, the control unit 100a refers to the information stored in the inhibit network list storage area 104b and determines whether or not the base station BS sending the notified information received in step 3c is a base station which belongs to the roaming inhibit network.

If the network to which the base station BS belongs is stored in the inhibit network list storage area 104b, the control unit 100a determines that the base station BS is an unavailable base station which belongs to the roaming inhibit network. The control unit 100a shifts to step 3i.

On the other hand, if the network to which the base station BS belongs is not stored in the inhibit network list storage area 104b, the control unit 100a determines that the base station BS may be a base station which belongs to the home network or a non-inhibited roaming network and which is available. The control unit 100a shifts to step 3e.

In step 3e, the control unit 100a controls the sender-receiver unit 102 to send the inherent identification information assigned to the mobile radio terminal apparatus and its user as stored in the memory unit 104, to the network to which the base station BS belongs, on the basis of the notified information received in step 3c and to start location registration. The control unit 100a shifts to step 3f.

In step 3f, the control unit 100a monitors receive signals of the sender-receiver unit 102 and determines whether or not the sender-receiver unit 102 has received Reject signal to reject the location registration from the network to which the base station BS belongs. If the sender-receiver unit 102 has received the Reject signal, the control unit 100a shifts to step 3h. If the sender-receiver unit 102 has not received the Reject signal, the control unit 100a shifts to step 3g.

In step 3g, the control unit 100a controls the sender-receiver unit 102 to execute the location registration with the network to which the base station BS belongs in predetermined steps. When the control unit 100a completes the location registration, the control unit 100a terminate the processing and shifts to a standby state of incoming/outgoing calls.

In step 3h, the control unit 100a stores the identification information of the network to which the base station BS belongs in the inhibit network list storage area 104b. The control unit 100a shifts to step 3i.

In step 3i, the control unit 100a stores, in the inhibit frequency list storage area 104c, identification information fn of the carrier frequency designated in step 3c and inhibit stop time Tm which elapses from a current time for a predetermined period in association with each other. The control unit 100a shifts to step 3a.

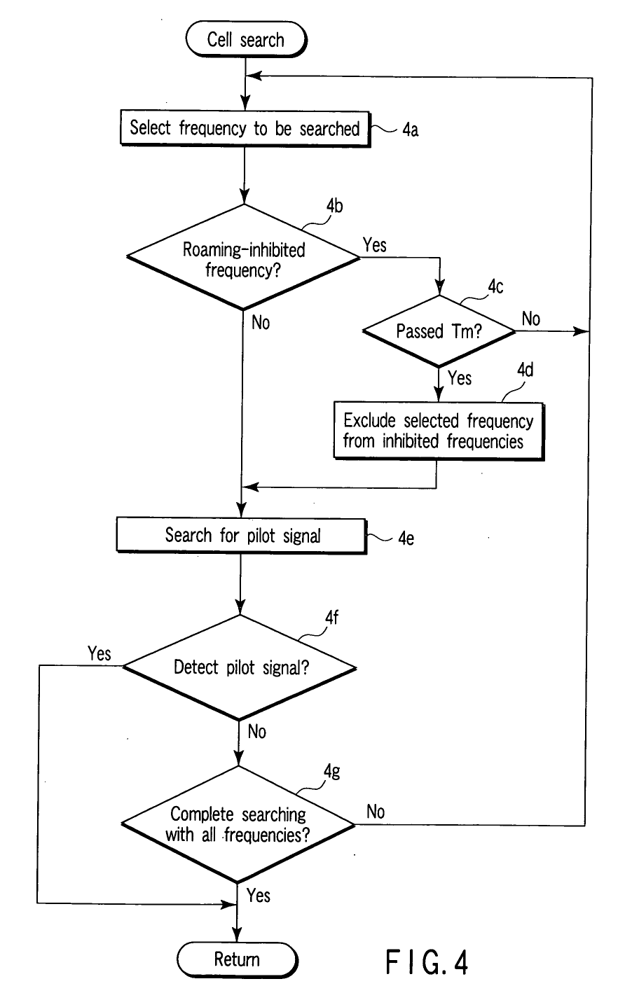

Next, the cell search processing executed in step 3a is described with reference to FIG. 4.

First, in step 4a, the control unit 100a selects one of the carrier frequencies stored in the frequency list storage area 104a, and shifts to step 4b. If the control unit 100a shifts from step 4c or 4g explained later to step 4a, the control unit 100a selects the carrier frequency other than the carrier frequency selected in step 4a.

In step 4b, the control unit 100a determines whether or not the carrier frequency selected in step 4a is the roaming inhibit carrier frequency stored in the inhibit frequency list storage area 104c.

If the carrier frequency selected in step 4a is the roaming inhibit carrier frequency, the control unit 100a shifts to step 4c. If the carrier frequency selected in step 4a is not the roaming inhibit carrier frequency, the control unit 100a shifts to step 4e.

In step 4c, the control unit 100a detects the inhibit stop time Tm corresponding to the carrier frequency selected in step 4a by referring to the inhibit frequency list storage area 104c, and determines whether or not the current time has passed the inhibit stop time Tm.

If the current time has passed the inhibit stop time Tm, the control unit 100a shifts to step 4d. If the current time has not passed the inhibit stop time Tm, the control unit 100a shifts to step 4a to select the other carrier frequency.

In step 4d, the control unit 100a deletes the identification information fn of the carrier frequency selected in step 4a and the inhibit stop time Tm corresponding thereto in the inhibit frequency list storage area 104c. The control unit 100a shifts to step 4e.

In step 4e, the control unit 100a designates the carrier frequency selected in step 4a, for the sender-receiver unit 102, and urges the sender-receiver unit 102 to receive the pilot signal with the carrier frequency. The control unit 100a shifts to step 4f.

In step 4f, the control unit 100a determines whether or not the pilot signal could be received in step 4e. If the pilot signal could be received, the control unit 100a terminates this processing and shifts to step 3b. If the pilot signal could not be received, the control unit 100a shifts to step 4g.

In step 4g, the control unit 100a determines whether or not the control unit 100a selected all of the carrier frequencies stored in the frequency list storage area 104a in step 4a. If the control unit 100a selected all of the carrier frequencies, the control unit 100a terminates this processing and shifts to step 3b. If the control unit 100a did not select all of the carrier frequencies, the control unit 100a shifts to step 4a to select the other carrier frequencies.

In the mobile radio terminal apparatus having the above-described structure, if the location registration is attempted via the detected base station BS and then rejected, the identification information of the network to which the base station BS belongs, and the identification information of the carrier frequency used for the communications with the base station BS are stored, and the cell with which communications can be established is detected on the basis of the identification information.

Thus, since the cell detection is not executed with the network in which roaming is inhibited or with the carrier frequency with which roaming cannot be executed, unnecessary searching for the pilot signal or reception of the notified information is not executed.

For this reason, even if the mobile radio terminal apparatus is located within the roaming inhibit network area, electric power to be consumed to receive the pilot signal and notified information sent from the base station can be reduced and the delay of cell detection of the home network/roaming network caused by unnecessary notified information reception can be prevented.

In addition, a time limit is set for the carrier frequency to be inhibited. If the time limit has elapsed, the carrier frequency is not inhibited. For this reason, when the operational environment changes due to user's movement, the available carrier frequency can be prevented from being excluded from carrier frequencies to be searched.

In the above-described first embodiment, cell search is executed in view of the carrier frequencies stored in the frequency list storage area 104a other than the carrier frequencies stored in the inhibit frequency list storage area 104c. Instead of this, however, cell search may be executed in view of the carrier frequencies stored in the frequency list storage area 104a other than the carrier frequencies in a band of predetermined width which includes the carrier frequencies stored in the inhibit frequency list storage area 104c as central frequencies.

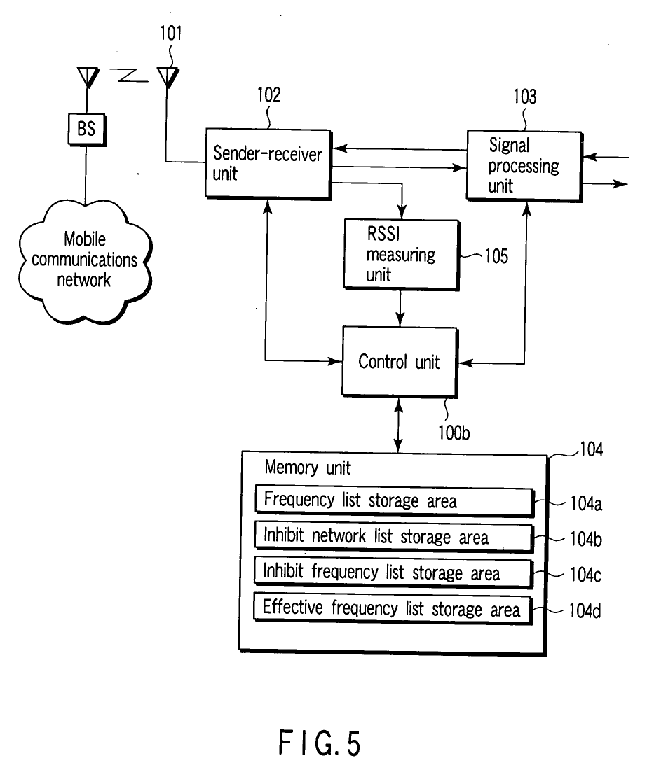

Next, a mobile radio terminal apparatus according to a second embodiment of the present invention will be described. FIG. 5 shows a structure thereof. The mobile radio terminal apparatus comprises an RSSI (Received Signal Strength Indicator) measuring unit 105, besides the structure of the mobile radio terminal apparatus shown in FIG. 1, and also comprises a control unit 100b instead of the control unit 100a. The memory unit 104 comprises an effective frequency list storage area 104d, besides the storage areas 104a, 104b and 104c shown in FIG. 1.

The RSSI measuring unit 105 measures a received signal field strength of the signal received by the sender-receiver unit 102. The control unit 100b is notified of the measured received signal field strength (RSSI). Of the identification information of the carrier frequencies stored in the frequency list storage area 104a, identification information of carrier frequencies which have higher RSSI than a predetermined threshold value is stored in the effective frequency list storage area 104d, on the basis of a result of RSSI measuring unit 105, by the control unit 100b.

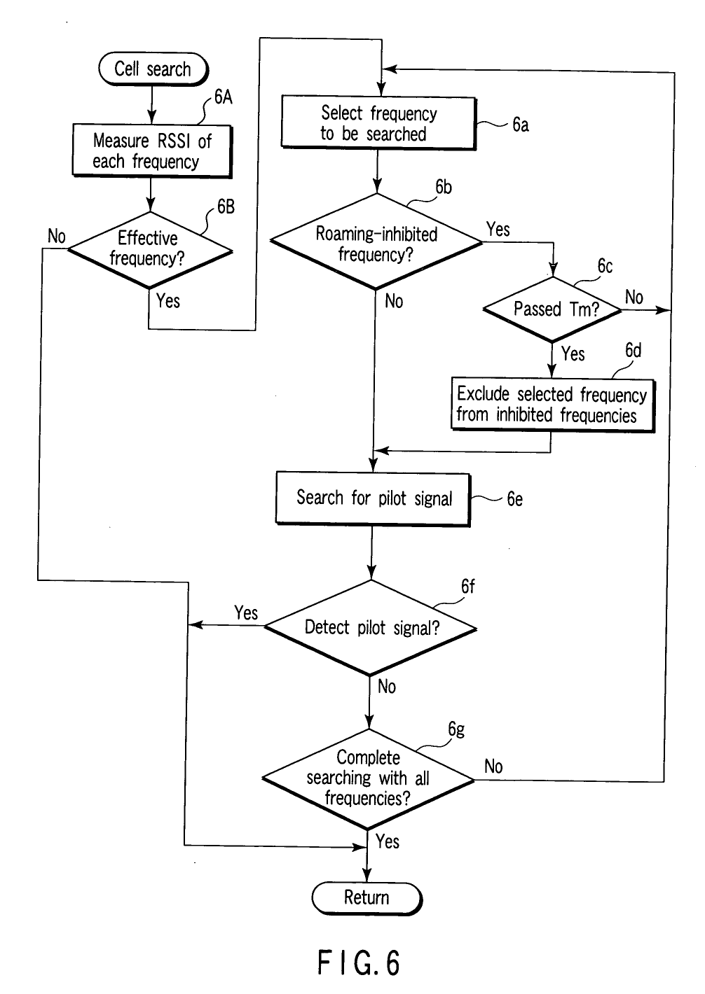

The control unit 100b executes the processing shown in FIG. 3, similarly to the control unit 100a. The control unit 100b executes processing shown in FIG. 6 instead of the processing shown in FIG. 4, as the processing of cell search in step 3a.

The same processing as that of the first embodiment is executed in view of execution of the processing shown in FIG. 3. Thus, the explanations of FIG. 3 are omitted and the processing of FIG. 6 corresponding to step 3a is described.

First, in step 6A, the control unit 100b sequentially assigns the carrier frequencies stored in the frequency list storage area 104a to the sender-receiver unit 102 and urges the sender-receiver unit 102 to sequentially receive the carrier frequencies stored in the frequency list storage area 104a.

The sender-receiver unit 102 thereby sequentially receives the carrier frequencies stored in the frequency list storage area 104a, and the received signals are output to the RSSI measuring unit 105. The RSSI measuring unit 105 measures the RSSI of the received signal of each carrier frequency and outputs a result of the measurement to the control unit 100b.

The control unit 100b detects the carrier frequency with which RSSI higher than a preset threshold value can be obtained, on the basis of the RSSI supplied from the RSSI measuring unit 105. The control unit 100b stores identification information of the detected carrier frequency in the effective frequency list storage area 104d and shifts to step 6B.

In step 6B, the control unit 100b determines whether or not there is a carrier frequency whose identification information is stored in the effective frequency list storage area 104d. If there is a carrier frequency whose identification information is stored in the effective frequency list storage area 104d, the control unit 100b shifts to step 6a. If there is not such a carrier frequency, the control unit 10b terminates this processing and shifts to step 3b.

In step 6a, the control unit 100b selects one of the carrier frequencies stored in the effective frequency list storage area 104d, and shifts to step 6b. If the control unit 100b shifts from step 6c or 6g explained later to step 6a, the control unit 100b selects the carrier frequency other than the carrier frequency selected in step 6a.

In step 6b, the control unit 100b determines whether or not the carrier frequency selected in step 6a is the roaming inhibit carrier frequency stored in the inhibit frequency list storage area 104c.

If the carrier frequency selected in step 6a is the roaming inhibit carrier frequency, the control unit 100b shifts to step 6c. If the carrier frequency selected in step 6a is not the roaming inhibit carrier frequency, the control unit 100b shifts to step 6e.

In step 6c, the control unit 100b detects the inhibit stop time Tm corresponding to the carrier frequency selected in step 6a by referring to the inhibit frequency list storage area 104c, and determines whether or not the current time has passed the inhibit stop time Tm.

If the current time has passed the inhibit stop time Tm, the control unit 100b shifts to step 6d. If the current time has not passed the inhibit stop time Tm, the control unit 100b shifts to step 6a to select the other carrier frequency.

In step 6d, the control unit 100b deletes the identification information fn of the carrier frequency selected in step 6a and the inhibit stop time Tm corresponding thereto in the inhibit frequency list storage area 104c. The control unit 100b shifts to step 6e.

In step 6e, the control unit 100b designates the carrier frequency selected in step 6a, for the sender-receiver unit 102, and urges the sender-receiver unit 102 to receive the pilot signal with the carrier frequency. The control unit 100b shifts to step 6f.

In step 6f, the control unit 100b determines whether or not the pilot signal could be received in step 6e. If the pilot signal could be received, the control unit 100b terminates this processing and shifts to step 3b. If the pilot signal could not be received, the control unit 100b shifts to step 6g.

In step 6g, the control unit 100b determines whether or not the control unit 100b selected all of the carrier frequencies stored in the frequency list storage area 104a in step 6a. If the control unit 100b selected all of the carrier frequencies, the control unit 100b terminates this processing and shifts to step 3b. If the control unit 100b did not select all of the carrier frequencies, the control unit 100b shifts to step 6a to select the other carrier frequencies.

In the mobile radio terminal apparatus having the above-described structure, RSSI is detected for each carrier frequency. On the basis of the detection result, the carrier frequencies considered effective for communications are detected. Of the carrier frequencies considered effective, the cell with which communications can be established is detected with the carrier frequencies other than the carrier frequency whose location registration is attempted and whose use is rejected.

The cell detection is not executed with the network in which roaming is inhibited or with the carrier frequency with which roaming cannot be executed, of the carrier frequencies which are considered effective since they have high RSSI. Thus, unnecessary searching for the pilot signal or reception of the notified information is not executed.

For this reason, even if the mobile radio terminal apparatus is located within the roaming inhibit network area, electric power to be consumed to receive the pilot signal and notified information sent from the base station can be reduced and the delay of cell detection of the home network/roaming network caused by unnecessary notified information reception can be prevented, similarly to the mobile radio terminal apparatus of the first embodiment. In addition, since the carrier frequencies with which the cell detection is executed are selected on the basis of the RSSI, the consumed power can be more reduced than the mobile radio terminal apparatus of the first embodiment.

In step 6A, RSSI is measured with all of the carrier frequencies stored in the frequency list storage area 104a. However, the present invention is not limited to this.

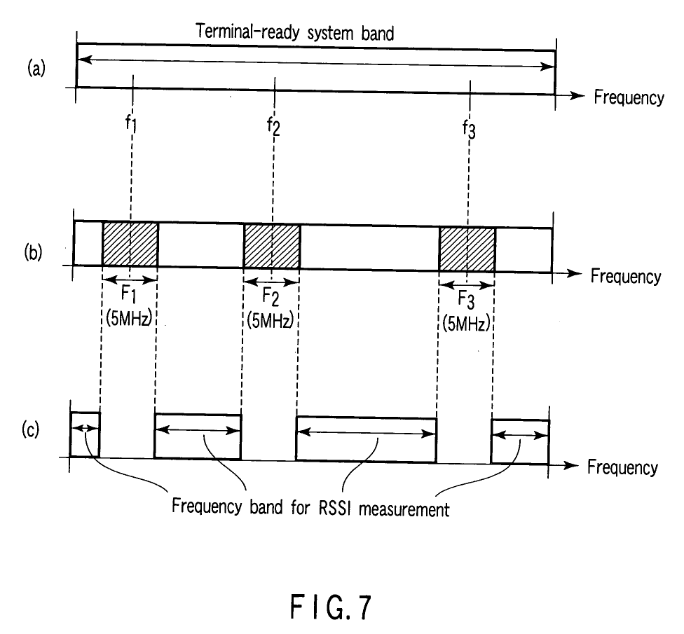

For example, by referring to the inhibit frequency list storage area 104c, RSSI may be measured with the carrier frequencies other than those stored in the inhibit frequency list storage area 104c. Moreover, RSSI may be measured with the carrier frequencies other than a band of predetermined width (for example, 5 MHz in W-CDMA) which includes the carrier frequencies stored in the inhibit frequency list storage area 104c as central frequencies. FIG. 7 shows an example of the measurement.

As shown in FIG. 7(a), the carrier frequencies stored in the inhibit frequency list storage area 104c are represented by f1, f2 and f3. In this case, in step 6a, the control unit 100b excludes frequency bands F1, F2 and F3 that include the carrier frequencies f1, f2 and f3 as central frequencies, from the frequency bands in which RSSI should be measured, as shown in FIG. 7(b).

In other words, in step 6a, the control unit 100b selects the carrier frequencies in the carrier frequency bands as shown in FIG. 7(c). Since this processing can narrow the bands of the carrier frequencies to be searched to an effective range, cell detection can be efficiently executed and the consumed power can be further reduced.

In the present embodiment, the W-CDMA mobile radio terminal apparatus is described. However, the present invention can also be applied to a GSM mobile radio terminal apparatus. Furthermore, the present invention can also be applied to a mobile radio terminal apparatus which corresponds to both systems of W-CDMA and GSM.

In the mobile radio terminal apparatus corresponding to two systems, the information of the carrier frequencies stored in the memory unit 104 is stored for each system. The control unit 100a and the control unit 100b can selectively execute the above-described processing with any of the systems that responds to the user's request via an operation unit (not shown).

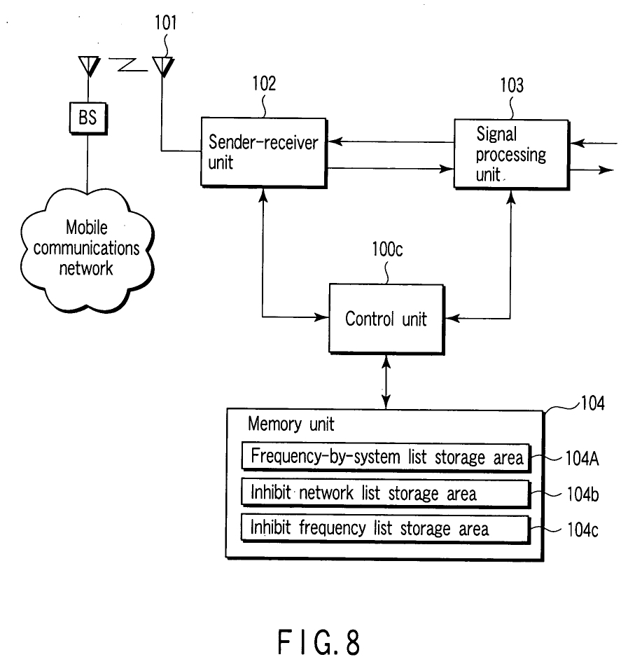

Next, a mobile radio terminal apparatus according to a third embodiment of the present invention will be described. FIG. 8 shows a structure thereof. The mobile radio terminal apparatus corresponds to two systems, for example, W-CDMA and GSM.

The apparatus comprises a control unit 100c instead of the control unit 100a in the mobile radio terminal apparatus shown in FIG. 1. The memory unit 104 comprises a frequency-by-system list storage area 104A instead of the frequency list storage area 104a shown in FIG. 1.

The frequency-by-system list storage area 104A stores lists of identification information about all of available carrier frequencies, in the home network and roaming network, in each of two systems S1 and S2.

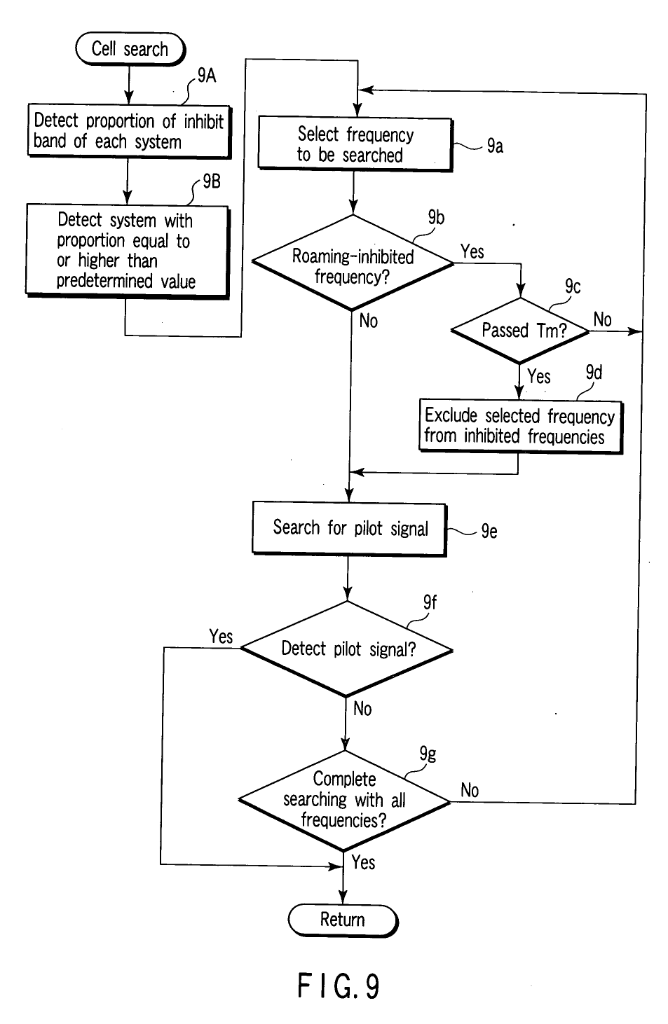

The control unit 100c executes the processing shown in FIG. 3 similarly to the control unit 100a. However, the control unit 100c executes processing shown in FIG. 9 instead of the processing shown in FIG. 4, as the cell search processing in step 3a.

Since the processing shown in FIG. 3 is executed similarly to the first embodiment, explanation of FIG. 3 is omitted and the processing shown in FIG. 9 corresponding to step 3a will be described.

First, in step 9A, the control unit 100c refers to the carrier frequency with which roaming cannot be carried out, as stored in the inhibit frequency list storage area 104c, and acquires an inhibit carrier frequency band which includes the carrier frequency as its centrals frequency. The control unit 100c acquires proportion of the inhibit carrier frequency band to the band used in each of systems S1 and S2, and shifts to step 9B.

In step 9B, the control unit 100c determines whether or not the proportion of the inhibit carrier frequency band in each of systems S1 and S2, as detected in step 9A, is equal to or higher than a preset threshold value, detects the system in which the proportion of the inhibit carrier frequency band is equal to or higher than a preset threshold value, and shifts to step 9a. The threshold value can be set at 0 to 100 percent.

In step 9a, the control unit 100c selects one of the carrier frequencies stored in the effective frequency list storage area 104d, other than the carrier frequencies of the system detected in step 9B, and shifts to step 9b. If the control unit 100c shifts from step 9c or 9g explained later to step 9a, the control unit 100c selects the carrier frequency other than the carrier frequency selected in step 9a.

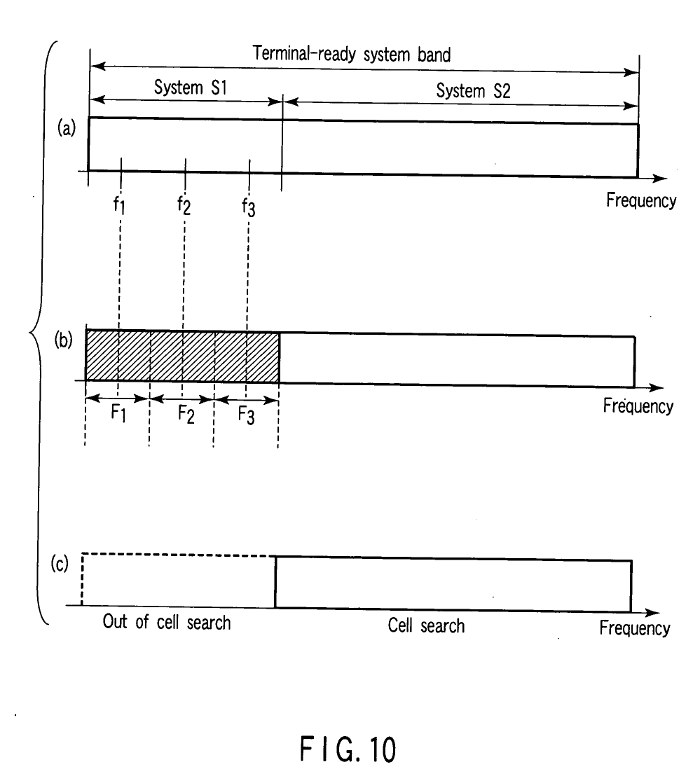

FIG. 10(a) shows the carrier frequency bands used respectively in systems S1 and S2. It is assumed here that identification information items of frequencies f1, f2, and f3 are stored in the inhibit frequency list storage area 104c.

It is also assumed that the proportion of inhibit carrier frequency bands F1, F2 and F3 that include the frequencies f1, f2, and f3 as the respective central frequencies, to the carrier frequency band of system S1, is 100 percent as shown in FIG. 10(b). This condition is detected by the control unit 100c in step 9A.

In step 9B, the control unit 100c excludes the carrier frequency band of system S1 from the band in which cell search should be executed since the proportion of the inhibit carrier frequency bands is higher than the threshold value. Thus, in step 9a, the control unit 100c executes cell search in the only carrier frequency band of the system S2 as shown in FIG. 10(c).

In step 9b, the control unit 100c determines whether or not the carrier frequency selected in step 9a is the roaming inhibit carrier frequency stored in the inhibit frequency list storage area 104c.

If the carrier frequency selected in step 9a is the roaming inhibit carrier frequency, the control unit 100c shifts to step 9c. If the carrier frequency selected in step 9a is not the roaming inhibit carrier frequency, the control unit 100c shifts to step 9e.

In step 9c, the control unit 100c detects the inhibit stop time Tm corresponding to the carrier frequency selected in step 9a by referring to the inhibit frequency list storage area 104c, and determines whether or not the current time has passed the inhibit stop time Tm.

If the current time has passed the inhibit stop time Tm, the control unit 100c shifts to step 9d. If the current time has not passed the inhibit stop time Tm, the control unit 100c shifts to step 9a to select the other carrier frequency.

In step 9d, the control unit 100c deletes the identification information fn of the carrier frequency selected in step 9a and the inhibit stop time Tm corresponding thereto in the inhibit frequency list storage area 104c. The control unit 100c shifts to step 9e.

In step 9e, the control unit 100c designates the carrier frequency selected in step 9a, for the sender-receiver unit 102, and urges the sender-receiver unit 102 to receive the pilot signal with the carrier frequency. The control unit 100c shifts to step 9f.

In step 9f, the control unit 100c determines whether or not the pilot signal could be received in step 9e. If the pilot signal could be received, the control unit 100c terminates this processing and shifts to step 3b. If the pilot signal could not be received, the control unit 100c shifts to step 9g.

In step 9g, the control unit 100c determines whether or not the control unit 100c selected all of the carrier frequencies stored in the frequency list storage area 104a in step 9a. If the control unit 100c selected all of the carrier frequencies, the control unit 100c terminates this processing and shifts to step 3b. If the control unit 100c did not select all of the carrier frequencies, the control unit 100c shifts to step 9a to select the other carrier frequencies.

In the mobile radio terminal apparatus having the above-described structure, the proportion of the inhibit carrier frequency band in which roaming cannot be carried out, in each of the systems, is acquired. In the system in which the proportion is equal to or higher than the threshold value, cell search is not carried out. Even in the system in which cell search should be carried out, the cell capable of communications is detected in the frequency band other than the carrier frequency band in which roaming cannot be carried out.

Thus, cell search is not carried out in the system having high proportion of the inhibit carrier frequency band and poor efficiency of the cell search. Therefore, electric power to be consumed to receive the pilot signal and notified information sent from the base station can be reduced and the delay of cell detection of the home network/roaming network caused by unnecessary notified information reception can be prevented.

In the above-described case, the CDMA is employed as a communication scheme. However, the present invention can be applied to the GSM. If the communication scheme is the GSM, the specific channel is decoded in step 9e and it is determined whether or not the specific channel has been successfully decoded in step 9f.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, in the above-described embodiments, the carrier frequency with which cell search is carried out irrespective of the user's request for an outgoing call. However, if the user makes an outgoing call to a police station, a fire department, or the like in case of an emergency, cell search may be carried out and then location registration may be carried out, without limiting the carrier frequencies with which the cell search should be executed.

The memory unit 104 may preliminarily store a special number for emergency call. If the special number is input via the operation unit, the control unit 100 determines the call as the emergency call.

In the first and second embodiments, in step 3i, the inhibit frequency list storage area 104c stores the identification information fn of the carrier frequency designated in step 3c and the inhibit stop time Tm which elapses from a current time for a predetermined period, in association with each other. In steps 4c, 6c and 4d, 6d, the carrier frequency with which the inhibit stop time Tm has elapsed is excluded from the carrier frequencies which should be inhibited and is used to search for the pilot signal.

Instead of this, for example, an equivalent processing is executed. In other words, in step 3i, the inhibit frequency list storage area 104c stores the identification information fn of the carrier frequency designated in step 3c and the time of designation which is considered as time information Tnow, in association with each other. In steps 4c and 6c, the time information Tnow is compared with the current time.

If a predetermined time has elapsed since the time information Tnow, the selected carrier frequency may be excluded from the carrier frequencies which should be inhibited and may be used to search for the pilot signal in steps 4d and 6d. In this processing, too, the same advantage can be obtained.

In addition, in the first and second embodiments, the carrier frequency with which the inhibit stop time Tm has elapsed is deleted in the inhibit frequency list storage area 104c and is used to search for the pilot signal in steps 4c, 6c and steps 4d, 6d.

To obtain the same advantage as this processing, the following processing is executed. The carrier frequency corresponding to the inhibit stop time Tm which has elapsed prior to the current time, of the carrier frequencies stored in the inhibit frequency list storage area 104c, may be deleted in the inhibit frequency list storage area 104c, in an interval between steps 4a and 4b, or steps 6a and 6b. The same advantage can also be obtained from this processing. Even if this processing is executed before step 4a or 6a, the same advantage can be obtained.

In step 3i, if the inhibit frequency list storage area 104c stores the identification information fn of the carrier frequency designated in step 3c and the time information Tnow representing the time of designation, in association with each other, the following processing may be executed.

The time information Tnow corresponding to the carrier frequencies stored in the inhibit frequency list storage area 104c is compared with the current time, and the carrier frequency corresponding to the time information Tnow that a predetermined time has elapsed, is deleted in the inhibit frequency list storage area 104c, in the interval between steps 4a and 4b, or steps 6a and 6b. The same advantage can also be obtained from this processing. Even if this processing is executed before step 4a or 6a, the same advantage can be obtained.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus for communicating by radio with base stations in a radio communications network:
a first memory configured to store carrier frequencies available for connections with the base stations;
a receiver configured to receive radio signals from the base stations;
a second memory configured to store carrier frequencies at which the receiver receives signals to reject connections with the base stations; and
a searcher configured to search a connectable base station at the carrier frequencies stored by the first memory other than the carrier frequencies stored by the second memory.

2. The apparatus according to claim 1, wherein the second memory stores time information based on the reception and the carrier frequencies used for the connection with the base station in association with each other when the signal to reject connection with the base station is received; and
the searcher searches for the connectable base station at the carrier frequencies stored by the first memory other than the carrier frequencies stored by the second memory and at the carrier frequencies stored by the second memory associated with the time information from which a predetermined time has elapsed.

3. The apparatus according to claim 1, wherein the second memory stores time information based on the reception and the carrier frequencies used for the connection with the base station in association with each other and the searcher searches for the connectable base station at the carrier frequencies stored by the first memory other than the carrier frequencies stored by the second memory, and deletes the carrier frequencies associated with the time information from which a predetermined time has elapsed; and
the searcher searches for the connectable base station at the carrier frequencies stored by the first memory other than the carrier frequencies stored by the second memory.

4. A radio communication apparatus for communicating by radio with base stations in a radio communications network:
a inhibit network memory configured to store identification information of a radio communications network in which the apparatus's roaming is not permitted;
a first memory configured to store carrier frequencies available for connections with the base stations;
a receiver configured to receive radio signals from the base stations to obtain identification information of a radio communications network to which each of the base stations belong;
a second memory configured to store carrier frequencies used for connections with the base stations of which identification information is stored by the inhibit network memory; and
a searcher configured to search a connectable base station at the carrier frequencies stored by the first memory other than the carrier frequencies stored by the second memory.

5. The apparatus according to claim 4, wherein the second memory stores time information based on the reception and the carrier frequencies used for the connection with the base station in association with each other when the obtained identification information is stored by the inhibit network memory; and
the searcher searches for the connectable base station at the carrier frequencies stored by the first memory other than the carrier frequencies stored by the second memory and at the carrier frequencies stored by the second memory associated with the time information from which a predetermined time has elapsed.

6. The apparatus according to claim 4, wherein the second memory stores time information based on the reception and the carrier frequencies used for the connection with the base station in association with each other and the searcher searches for the connectable base station at the carrier frequencies stored by the first memory other than the carrier frequencies stored by the second memory when the obtained identification information is stored by the inhibit network memory, and deletes the carrier frequencies associated with the time information from which a predetermined time has elapsed; and
the searcher searches for the connectable base station at the carrier frequencies stored by the first memory other than the carrier frequencies stored by the second memory.

7. The apparatus according to claim 1, wherein the searcher searches for the connectable base station at the carrier frequencies stored by the first memory other than frequency bands of a predetermined bandwidth in which the carrier frequencies stored by the second memory are included as central frequencies.

8. The apparatus according to claim 4, wherein the searcher searches for the connectable base station at the carrier frequencies stored by the first memory other than frequency bands of a predetermined bandwidth in which the carrier frequencies stored by the second memory are included as central frequencies.

9. A mobile radio terminal apparatus configured to carry out radio communications selectively with a base station accommodated in a first mobile communications network and a base station accommodated in a second mobile communications network, comprising:
first storage means for storing carrier frequencies which are available for communications with the base station;
receiving means for receiving a radio signal from the base station;
second storage means for storing carrier frequencies used for connection with the base station if the receiving means receives a signal to reject the connection from the base station; and
searching means for searching for a connectible base station, with the carrier frequencies stored by the first storage means other than the carrier frequencies stored by the second storage means, outside any one of a first frequency band used in the first mobile communications system and a second frequency band used in the second mobile communications system where a proportion of a predetermined bandwidth including the carrier frequencies stored by the second storage means as central frequencies to the frequency band is equal to or higher than a preset threshold value.

10. A mobile radio terminal apparatus configured to carry out radio communications selectively with a base station accommodated in a first mobile communications network and a base station accommodated in a second mobile communications network, comprising:
inhibit network storage means for storing identification information of a mobile communications network in which roaming is not permitted;
first storage means for storing carrier frequencies which are available for communications with the base station;
receiving means for receiving a radio signal from the base station and receiving identification information of a mobile communications network to which the base station belongs;
second storage means for storing carrier frequencies used for connection with the base station if the identification information received by the receiving means is stored by the inhibit network storage means; and
searching means for searching for a connectible base station, with the carrier frequencies stored by the first storage means other than the carrier frequencies stored by the second storage means, outside any one of a first frequency band used in the first mobile communications system and a second frequency band used in the second mobile communications system where a proportion of a predetermined bandwidth including the carrier frequencies stored by the second storage means as central frequencies to the frequency band is equal to or higher than a preset threshold value.
